(19) United States
(12) Patent Application Publication
(10) Pub. No.: US 2011/0115837 A1
(43) Pub. Date: May 19, 2011

(54) Monitor Retraining Device

(76) Inventor: Nelson de Sa e Silva, La Grange, IL (US)

(21) Appl. No.: 12/948,909

(22) Filed: Nov. 18, 2010

Related U.S. Application Data
(60) Provisional application No. 61/262,252, filed on Nov. 18, 2009.

(51) Int. Cl. G09G 5/02

(52) U.S. Cl. 345/691

(57) ABSTRACT

A monitor retraining device includes a handheld housing, a controller disposed within the housing, and a connector connected to the controller and connectable directly to a monitor having a screen. The controller has a first state wherein the controller provides an output signal to the connector to cause the monitor to display a white image over the entire screen for a first time period, and a second state wherein the controller provides no output signal to the connector to cause the monitor to display a black image over the entire screen for a second time period, the controller automatically alternating between the first and second states without feedback as to the white image or the black image displayed.

This application claims the benefit of U.S. Application No. 61/262,252, filed Nov. 18, 2009, which is hereby incorporated by reference in its entirety in the present application.

### BACKGROUND

This patent is directed to a device used to adjust a monitor, and, in particular, to a device used to retrain a monitor that has experienced image variation.

### SUMMARY

According to an aspect of the present disclosure, a monitor retraining device for a monitor having a screen is provided. The device includes a handheld housing, a controller disposed within the housing, and a connector connected to the controller and connectable directly to the monitor. The controller has a first state wherein the controller provides an output signal to the connector to cause the monitor to display a white image over the entire screen for a first time period, and a second state wherein the controller provides no output signal to the connector to cause the monitor to display a black image over the entire screen for a second time period, the controller automatically alternating between the first and second states without feedback as to the white image or the black image displayed.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a block diagram of an embodiment of a monitor retraining device according to the present disclosure;

FIG. 2 is a schematic of an embodiment of a controller used in a monitor retraining device according to the present disclosure;

FIG. 3 is a schematic of an alternative embodiment of a controller used in a monitor retraining device according to the present disclosure;

FIG. 4 is a flowchart of a method of operation of a monitor retraining device according to the present disclosure;

FIG. 5 is a top view of an embodiment of a housing used in a monitor retraining device according to the present disclosure, with a portion of the housing removed to expose an embodiment of a controller used in the device;

FIG. 6 is a cross-sectional side view of the housing of FIG. 4; and

FIG. 7 is an end view of the housing of FIG. 4.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

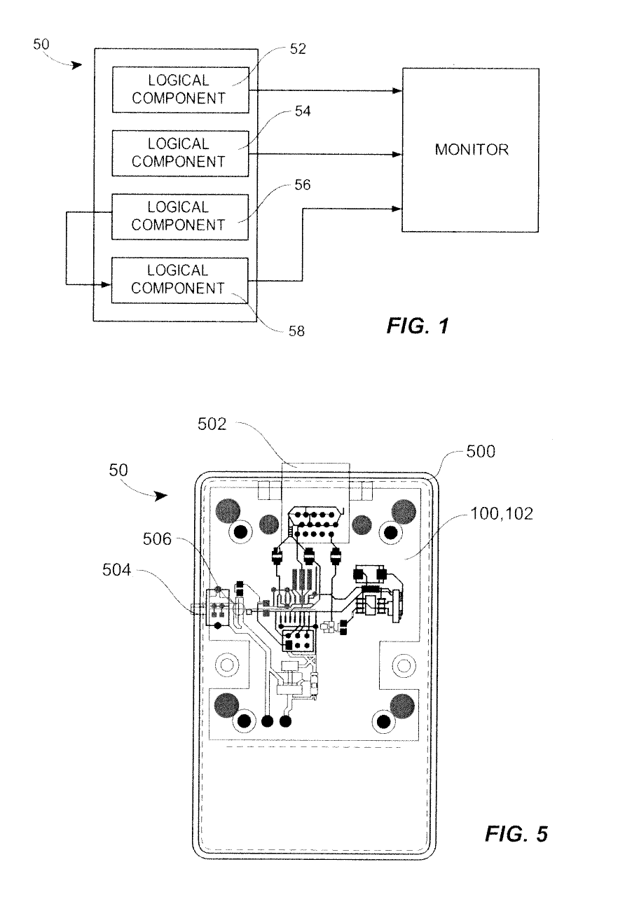

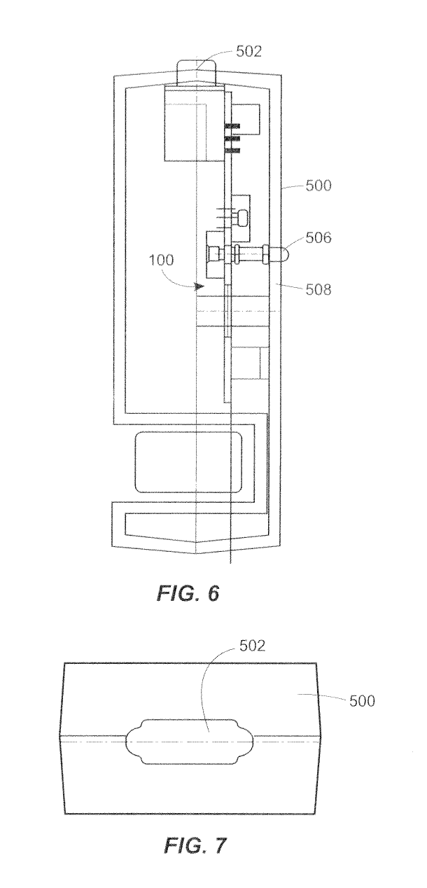

FIGS. 1-7 illustrate various embodiments of controllers and housings for use in a monitor retraining device, such as may be useful in correcting image variation in monitors, including televisions, computer monitors and the like. According to particular embodiments, these monitors may be so-called pixel-based display devices.

Pixel-based display devices typically will include components for processing instructions from an input source, and a pixel field that converts the processed instructions into images. Input sources, such as computers and DVD players, send instructions to the display device in two forms: horizontal and vertical synchronization signals, and signals that specify the color and intensity of light to be emitted by each pixel.

According to certain embodiments, the pixels are controlled by an electron gun in the display device, although more generically the pixels may be controlled by a display controller. The display controller moves across the pixel field at a predetermined refresh frequency, and typically sends an electrical signal to each pixel in the order in which it appears in the pixel field. The electrical signal tells the pixel which color or combination of colors in the red, green, and blue spectrum to emit and the light intensity of each color.

In those embodiments utilizing an electron gun, the electron gun scans the entire pixel field repeatedly at the defined refresh frequency, always firing at the same pixel at the same point in time during the refresh cycle. Because the gun aims at each pixel for the same period of time as any other pixel, each pixel corresponds to a particular point in time in the refresh cycle. Therefore, it is possible to know which pixel the gun is addressing by knowing the point in time in the refresh cycle.

The input source tells the display device the refresh frequency to use through the control of the horizontal and vertical synchronization signals; at the present time, this refresh frequency must match one of a finite number of predefined industry standard refresh frequencies. The duration of the horizontal and vertical signals, as well as the ratio of horizontal signals to vertical signals, are what tell the display device which industry standard refresh frequency to use. For example, if the input source sends 480 horizontal synchronization signals at 31.77 microsecond intervals, followed by a vertical synchronization signal at a 16.6 millisecond interval, then the display device knows the refresh frequency is the industry standard 640×480 60 Hz frequency. The horizontal and vertical signals are sent over and over in an endless loop in order to maintain synchronization between the input source and the display device.

At the example frequency of 640×480 60 Hz, the electron gun is firing at each pixel for 0.0397 microseconds. With this knowledge, the input source can determine which pixel is being addressed at a given point in time: the first pixel at 0.0 microseconds, the second at 0.0397 microseconds, the third at 0.0794 microseconds, and so forth throughout the entire pixel refresh cycle. Creating an image on the display device is then a matter of varying the color and intensity signals at the points in time that align with the frequency of the electron gun.

Over time, display devices may fail to accurately reproduce the colors and light intensities as instructed by an input source, such that the image exhibits variations relative to the original image or a standard image. The failure to accurately reproduce the colors and light intensities may result in any of a variety of phenomena. These phenomena are referred to by various names, such as burn-in, ghosting, stuck pixels, etc. These phenomena have been a factor in the performance of display devices from the earliest cathode ray televisions and computer monitors to modern LCD televisions and display panels. The phenomena may be unpleasant and distracting to the viewer.

For example, when a monitor displays an image for a prolonged period of time (for example, anywhere from several minutes to several hours), the image will appear to be displayed, at a lighter intensity, behind any image that is displayed later on that monitor. The image displayed may be a television test pattern, a game controller menu, or a computer desktop, for example. In cathode ray tubes (CRTs), it is believed that this faint image may be a product of the breakdown of the individual phosphor elements. When discussed relative to CRTs, the phenomenon is commonly referred to as burn-in. In liquid crystal displays (LCDs), the faded image may be a product of the crystals developing a memory for certain patterns that produce certain colors; it is believed that this may be the result of an abnormal twist in the LCD filaments. When discussed relative to LCDs, the phenomenon is commonly referred to as image persistence. In plasma displays, it is believed that similar phenomenon may be the result of discharging phosphorous in the individual pixels.

In certain other cases, it may be that the input source is not correctly providing instructions to the display device, and the phenomena may be caused not simply as a result of display of an image for a prolonged duration. That is to say, input sources may develop inconsistencies in the color and light intensity signals they send to the display device. Over time, these inconsistencies can reinforce sub-optimal color and light intensity reproduction at specific pixels in the pixel field of the display device. In other words, just using the same input source over a period of time can train the display device to “memorize” the inconsistencies in the color and light intensity signals, thus deteriorating the color and light intensity capacity of the pixel field itself.

According to the present disclosure, a monitor retraining device 50 would work to reverse burn-in/image persistence or other phenomena by alternating between high intensity white and black images. That is, the device 50 would work to retrain the pixels in a pixel-based display device to produce the original range of colors and light intensities for which the pixels were originally designed, according to certain embodiments across the entire pixel field. It is believed that this may be the result of aging all of the phosphorous elements equally, or removing the abnormal twist of the LCD filaments. In particular, the device 50 would control the monitor to display a white image (equal voltage and current to the red, green and blue receptors) for a first time period. Subsequently, the device 50 to display a black image (no current to the red, green and blue receptors) for a second time period. The device 50 would then alternate back and forth between the white and black images until the process is complete.

The first and second time periods are preferably the same, but they could be different. Each time period may be on the order of several seconds, and according to certain embodiments, the time periods may be between seven to ten seconds. According to other embodiments, the first and second time periods may be between 100 milliseconds and 15 seconds, or more particularly between 10 milliseconds and 5 seconds. According to still other embodiments, the first and second time periods may be between 10 seconds and five minutes. The process may be complete once a certain number of images have been displayed, or an overall time period for retraining has elapsed. According to certain embodiments, the overall duration of the process may be on the order of several minutes, and according to certain embodiments, the overall time period may be ten to twenty minutes.

As illustrated in FIG. 1, the monitor retraining device 50 may include a plurality of logical components, which may be implemented as a solid-state controller, as software operating within a processor, or otherwise. In particular, the device may include four logical components 52, 54, 56, 58. Logical component 52 may control the duration and frequency of the horizontal synchronization signal, while logical component 54 may control the duration and frequency of the vertical synchronization signal. Logical component 56 may control the duration and frequency of the color and light intensity signal. Logical component 58 may control the duration and frequency of the alternating white and black images.

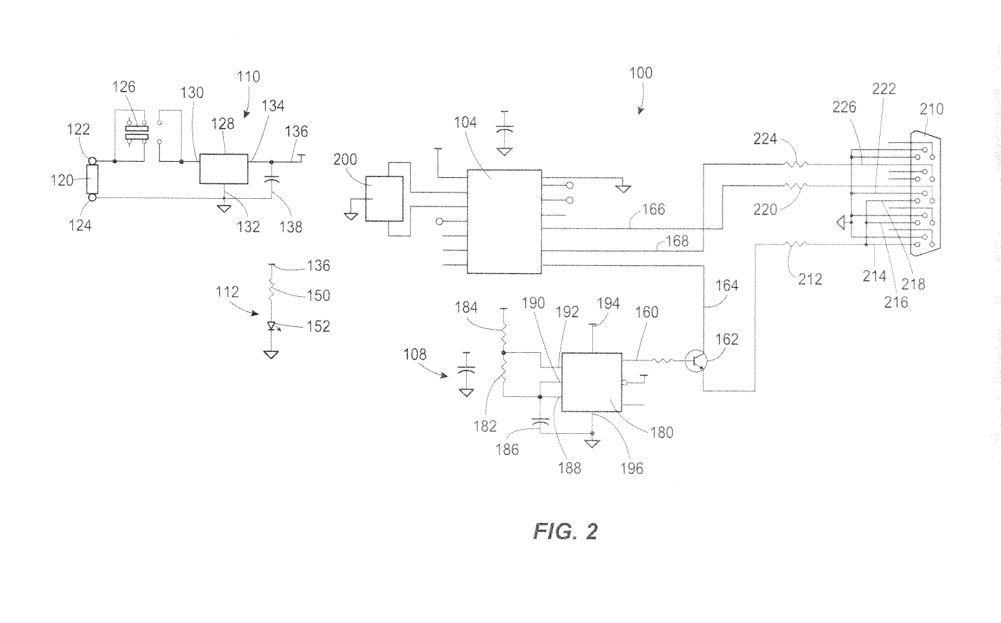

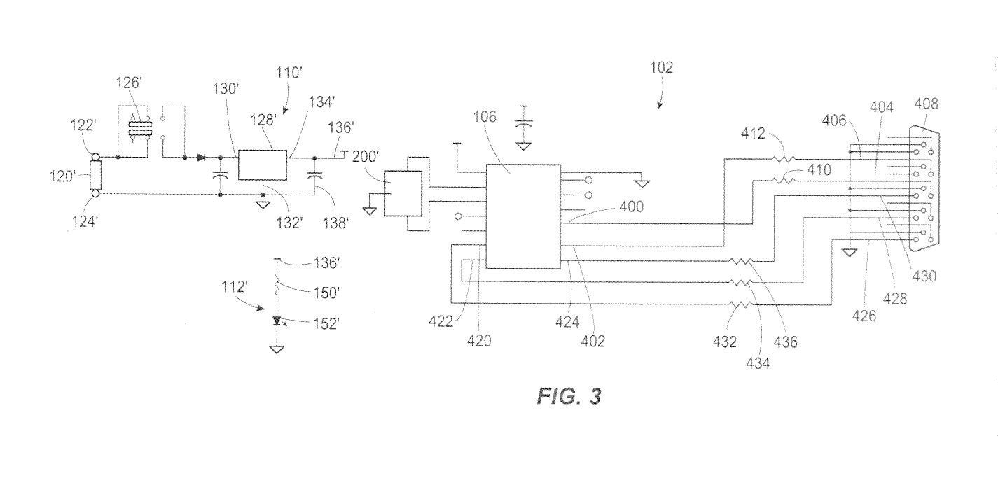

FIGS. 2 and 3 are illustrations of solid-state controllers 100, 102, with programmable processor and associated circuitry, that may be programmed to carry out the four logical components mentioned. The controllers 100, 102 illustrate two variants, although it will be recognized these are merely exemplary embodiments, and that still further embodiments may be developed that are encompassed by the present disclosure. It will also be recognized that while both controller 100, 102 include a programmable microcontroller 104, 106 (such as a PIC16F505 microcontroller available from Microchip Technology Inc. of Chandler, Ariz.), the major distinction between the controllers 100, 102 is that the controller 100 includes a timing circuit 108 separate from the microcontroller 104, while the controller 102 incorporates the function of the timing circuit 108 into the microcontroller 106.

Turning first to the controller 100, it will be recognized that the control 100 includes the microcontroller 104, the timing circuit 108, a power supply 110, and light circuit 112. Setting the microcontroller 104 and the timing circuit 108 aside for the moment, the structure and operation of the power supply 110 and light circuit 112 are discussed first. Moreover, as the power supply and the light circuit illustrated in regard to the controller 100 are substantially the same as the power supply and light circuit illustrated in regard to the controller 102, similar reference numerals are used for similar elements of the power supply and light circuits of each of the controllers 100, 102 (with the addition of a prime to the reference numerals for the controller 102). As a further consequence, the power supply 110 and light circuit 112 are described only once relative to the illustration of the controller 100.

To begin, the illustrated power supply 110 includes a battery 120 (such as a 9V battery) connected between first and second contacts 122, 124. The first contact 122 is connected to a switch 126, while the second contact 124 is connected to ground. The switch 126 is also connected to a 3-terminal positive voltage regulator 128 at a first terminal 130 of the regulator 128. A second terminal 132 of the regulator 128 is also connected to ground. The third terminal 134 of the regulator may provide +5V output 136 for the remainder of the controller 100, and a capacitor 138 (for example a 1 μF capacitor) may also be connected between the voltage output 136 and ground to assist with the transient response, although the capacitor 138 may be omitted as it generally may not be required for stability according to many embodiments. According to certain embodiments, the regulator 128 may be a LM340MP-5.0 regulator, such as may be available from National Semiconductor of Santa Clara, Calif.

Of course, other power supplies may be used instead of the illustrated power supply, which other supplies may use a series or parallel combination of batteries or no battery at all. That is, while the illustrated controllers 100, 102 utilize an on-board power supply, it will be recognized that the controller 100, 102 may obtain the voltage required from a source that resides outside the housing of the device, for example in the form of a power converter that is coupled to the controller 100, 102 and the electric mains. However, according to the illustrated embodiments, the power supply is housed in the same housing as the controller 100, 102, and utilizes one or more batteries to generate a DC output voltage.

The light circuit 112 includes a resistor 150 and a light emitting diode 152. The resistor 150 and the light emitting diode 152 are connected in series between the +5V output 136 and ground. Consequently, when the switch 126 is closed, such that the battery 120 is in circuit with the regulator 128, the diode 152 will provide a visible indication that the controller 100 is on.

It will be recognized that other circuits may be used instead or in addition to the light circuit 112 to provide other visible indicators to the user. Considering that it does not necessarily follow that the controller 100 is operating so as to carry out the monitor retraining method simply because to that the power supply 110 is providing voltage to the remainder of the controller 100, certain embodiments may provide additional visible indicators of the function of the device. For example, a light circuit may be included to provide an indication of a potential fault with the connection to the monitor resulting in failure of the device to retrain the monitor, as opposed to a potential fault with the power supply 110 (e.g., the battery 120) instead.

As noted above, the illustrated controller 100 includes a separate timing circuit 108 in addition to the microcontroller 104. The timing circuit 108 is used to change between the white and black screens. In particular, an output 160 of the timing circuit 108 is used to activate a transistor 162, thereby selectively coupling an output 164 of the microcontroller 104 to three pins (Red, Green, and Blue) of a connector that is coupled to the controller 100, 102 and that is coupleable to the monitor to be retrained. The microcontroller 104 is separately programmed to provide two other outputs 166, 168 that are coupled to two other pins of the controller to control the horizontal and vertical synchronization, respectively.

As illustrated, the timing circuit 108 includes a timer 180, such as the ICM7555 RC timer available from Maxim Integrated Products, Inc. of Sunnyvale, Calif. As configured according to the illustration, the timing device 180 is an astable timer with a frequency and duty cycle that vary in accordance with the resistors used. That is, the timing circuit 108 includes two resistors 182, 184 and a capacitor 186. Two pins (#2, #6) 188, 190 of the timing device 180 are connected via the capacitor 186 to ground. The junction of pins (#2, #6) 188, 190 is also connected via the first resistor 182 to a pin (#7) 192, the junction of pin (#7) 192 and resistor 182 is connected to the +5V output via the second resistor 184. The pin (#8) 194 is also coupled to the +5V output of the power supply 110, while pin (#1) 196 is connected directly to ground.

As noted above, this timing circuit 108 is used in conjunction with the microcontroller 104 to vary the outputs to the monitor to be retrained in conjunction with the general method of operation illustrated above. To this end, the microcontroller 104 is used in conjunction with an oscillator 200 that provides an input to the microcontroller 104 to be used in setting the speed of operation of the microcontroller 104. Also, as noted above, the microcontroller 104 has three outputs 164, 166, 168 that are controlled directly or in conjunction with the timing circuit 108 to provide the method of operation of the device 50.

As illustrated, these outputs 164, 166, 168 are either directly or indirectly connected so as to be coupled to pins of a conventional VGA connector 210, according to the illustrated embodiment. In particular, the output 164 is coupled (via the transistor 162 and a resistor 212 to each of pins (#1, #2, #3) 214, 216, 218, and thus controls the intensity of the Red, Green, and Blue receptors with a single signal from the microcontroller 104. The output 166 is connected via a resistor 220 to pin (#13) 222 to control the horizontal scan, while the output 168 is connected via a resistor 224 to pin (#14) 226 to control the vertical scan.

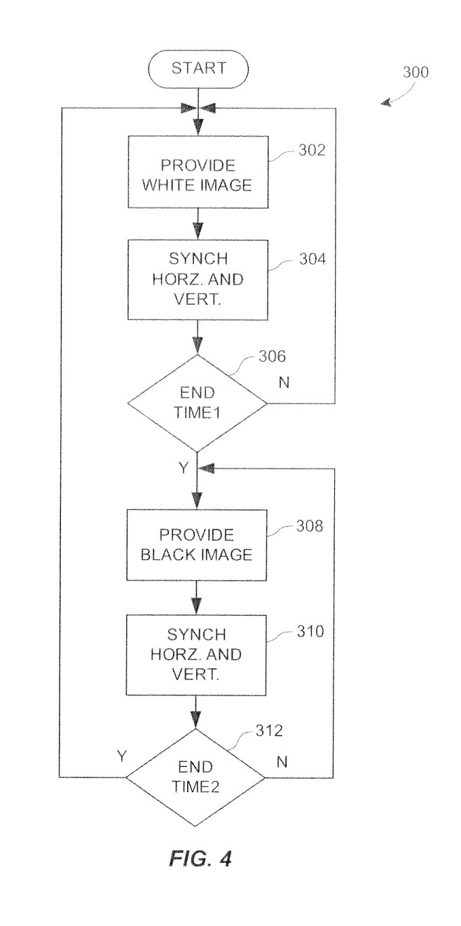

As also mentioned above, the controller 100, and in particular the microcontroller 104, may be programmed to carry out the disclosed method of retraining a monitor. As illustrated in FIG. 4, the method 300 may begin at a block 302 with the controller 100 providing an output signal that would cause the monitor to display a white image over the entire screen of the monitor. According to the illustrated embodiment of controller 100 in FIG. 2, the microcontroller 104 would provide an output at pin 164 that would cause equal voltage and current to be provided to the red, green and blue receptors. In accordance with operation of the timing circuit 108 activating the transistor 162, the output of pin 164 would be coupled to the pins 214, 216, 218 for a first time period. As a consequence, this step may be performed by the coordinated operation of the microcontroller 104 and the timing circuit 108.

As illustrated, the method 300 would continue at block 304 with the synchronization of the horizontal and vertical signals. According to the embodiment of FIG. 2, the microcontroller 104 would provide outputs 166, 168 coupled to pins 222, 226 to provide a horizontal synchronization signal and a vertical synchronization signal during the first time period. As such, it will be recognized that while the steps 302 and 304 are illustrated as sequential steps, the steps may occur, and can occur, concurrently.

As indicated at block 306, the controller 100 determines whether the first time period has elapsed. According to the illustrated controller 100, this is determined by the timing circuit 108. As the end of the first time period, which is in accordance with the duty cycle of the timer 180, the timing circuit 108 decouples the output 164 from the pins 214, 216, 218 by deactivating the transistor 162, so as to cause the monitor to display a black image (no current to the red, green and blue receptors) over the entire screen for a second time period (see block 306). However, until that time period elapses, the controller 100 continues to perform the steps of block 302, 304.

When the method 300 eventually proceeds to block 308, it is again necessary to synchronize the horizontal and vertical signals at block 310. For example, the microcontroller 104 may continue to provide outputs 166, 168 coupled to pins 222, 226 to synchronize the horizontal and vertical signals during the second time period. In fact, the microcontroller 104 may continue to synchronize the signals as the controller 100 transitions between providing the white image and providing the black image (blocks 302, 308), or the microcontroller 104 may be interrupted during the period during which the operation of the controller 100 transitions between the two major states of operation.

At block 312, the timing circuit 108 determines if the second time period has elapsed. If it has, then the method 300 returns to block 302; if not, then the method returns to block 308. The controller 100 would then automatically alternate back and forth between providing white and black images until the process is complete. The controller 100 performs this method without feedback as to the white image or the black image displayed; that is, this is an open loop method that does not rely upon feedback from the image displayed (whether determined internally of or externally to the monitor) for operation of or variation in the disclosed method.

As will be recognized with reference to the implementation of the method 300 of FIG. 4 as illustrated in the controller 100 of FIG. 2, some steps of the method 300 are performed by the microcontroller 104 alone or the timing circuit 108 alone, while other steps are performed by the operation of the microcontroller 104 in combination with the timing circuit 108. For example, the controller 100 provides a white image (block 302) or a black image (block 308) according to the operation of the microcontroller 104, as programmed, and the operation of the timing circuit 108. On the other hand, the synchronization of the horizontal and vertical signals (block 304, 310) is performed entirely by the microprocessor 104, as programmed, while the determination of the end of the first and second time periods (blocks 306, 312) is addressed by the timing circuit 108 alone.

It will be further recognized that the steps of the method 300 illustrated in FIG. 4 may instead be performed by the microcontroller 104 alone. The controller 102 illustrated in FIG. 3 is one embodiment with a microcontroller 106 programmed to carry out all of the steps of the method 300.

In particular, the controller 106 includes outputs 400, 402 that are coupled to pins (#13, #14) 404, 406 of a connector 408 via resistors 410, 412. These outputs 400, 402 are like the outputs 166, 168 of the controller 104 in that they control the synchronization of the horizontal and vertical signals, respectively. The controller 106 also includes outputs 420, 422, 424 that are coupled to pins (#1, #2, #3) 426, 428, 430 via resistors 432, 434, 436 to control the Red, Green, and Blue signals to provide either a white image or a black image.

According to such an embodiment, the microcontroller 106 would provide a signal (voltage) to the outputs 420, 422, 424 depending on whether the controller 102 is performing the step of block 302 or 308. Moreover, the microcontroller 106 would determine when the first and second time periods have elapsed (block 306, 312), and control the switch between the two states (providing a white image and providing a black image). As such, the programming of the microcontroller 106 may be more sophisticated than that of the microcontroller 104, and utilize additional outputs not addressed in the controller 100 illustrated in FIG. 2. However, even though the embodiment illustrated in FIG. 3 would include additional outputs and circuit elements (resistors) not present in the embodiment illustrated in FIG. 2, it is believed that the elimination of the separate timing circuit 108 may improve the simplicity of the controller 102, and as a consequence its stability and reliability.

According to certain embodiments, the device 50 would be portable. More specifically, a housing 500 for the device 50 would be manufactured such that the device 50 could fit the in the palm of your hand, such as is illustrated in FIGS. 5-7. For example, the handheld housing 500 may have a width, length, and depth on the order of one to several inches.

With reference to FIGS. 5-7, it will be noted that the controller 100, 102 is disposed within the housing 500 and is connected to a connector 502 (such as a VGA connector) that depends from the housing 500. The connector 502 would permit the controller 100, 102 to be connected directly to a monitor through an already-existing mating connector or port on the monitor. Thus, the output signals discussed previously would be provided to the connector 502 by the controller 100, 102, and thus to the monitor via the associated connector or port. As explained in greater detail above, the controller 100, 102 may also be connected to a power switch 504 and a light 506 that depend from cutouts in a wall 508 of the housing 500. The power switch 504 may be used to connect the controller 100, 102 to a power source 110, 110′, while the light 508 may be used to provide a visual indication to the user that the controller 100, 102 is connected to the power source 110, 110′ (which is also disposed in the handheld housing 500), the relative state of the power source 110, 110′, etc. It will be recognized that the light 506, which may be a light emitting diode (LED), may be substituted for another form of indicator, for example an audible indicator.

As noted, the power source 110, 110′ may include a battery, such as a nine-volt battery. Use of a battery may improve the portability of the device 50. Alternatively, the power source may be an on-board AC/DC adapter, or a separate AC/DC adapter connectable to the controller 100, 102 through the use of a separate connector. A highly portable embodiment of the device 50 may be of interest to consumers, television and computer repair technicians, and retailers because in this form, the device 50 may be used on multiple devices and stored in a small area, such as a desk drawer or tool box.

It is possible to have instead an embodiment of the device 50 wherein it is contained within the same housing as the display device. That is, the device 50 may be installed into a television or computer monitor by the manufacturer at the time the television or computer monitor is assembled. This may be of value to manufacturers because consumers will want the ability to retrain their display device without hiring a repair technician.

I claim:

1. A monitor retraining device for a monitor having a screen, the device comprising:
a handheld housing;
a controller disposed within the housing; and
a connector connected to the controller and connectable directly to the monitor,
the controller having a first state wherein the controller provides an output signal to the connector to cause the monitor to display a white image over the entire screen for a first time period, and a second state wherein the controller provides no output signal to the connector to cause the monitor to display a black image over the entire screen for a second time period, the controller automatically alternating between the first and second states without feedback as to the white image or the black image displayed.

2. The monitor retraining device according to claim 1, further comprising a power supply coupled to the controller and disposed within the handheld housing.

3. The monitor retraining device according to claim 2, wherein the power supply comprises a battery.

4. The monitor retraining device according to claim 1, wherein the controller comprises a programmable microcontroller, the programmable microcontroller programmed to provide an output signal to the connector to cause the monitor to display a white image over the entire screen for a first time period, to provide no signal to the connector to cause the monitor to display a black image over the entire screen for a second time period, and to automatically alternate between providing the signal and no signal.

5. The monitor retraining device according to claim 4, wherein the programmable microcontroller is programmed to provide a horizontal synchronization signal and a vertical synchronization signal to the connector.

6. The monitor retraining device according to claim 4, wherein the programmable microcontroller is programmed to provide equal signals to the connector, one each for a red receptor, a green receptor, and a blue receptor.

7. The monitor retraining device according to claim 1, wherein the first time period and the second time period are equal.

8. The monitor retraining device according to claim 7, wherein the first time period and the second time period are each between 100 milliseconds and 15 seconds long.

9. The monitor retraining device according to claim 9, wherein the first time period and the second time period are each 8 seconds long.
